(19) United States
(12) Patent Application Publication
(10) Pub. No.: US 2007/0146474 A1
(43) Pub. Date: Jun. 28, 2007

(54) Label printing system and method

(75) Inventors: Takanobu Kameda, Tokyo (JP); Hiroyasu Kurashina, Suwa-shi (JP)

Correspondence Address: BACON & THOMAS, PLLC, 625 SLATERS LANE, FOURTH FLOOR, ALEXANDRIA, VA, 22314, US

(73) Assignees: KING JIM CO., LTD., Tokyo (JP); SEIKO EPSON CORPORATION, Tokyo (JP)

(21) Appl. No.: 11/640,934

(22) Filed: Dec. 19, 2006

(30) Foreign Application Priority Data
Dec. 28, 2005 (JP) 2005-378066

(51) Int. Cl. B41J 2/435

(52) U.S. Cl. 347/262

(57) ABSTRACT

A label printing system according to the present invention includes a portable communication terminal and a label printing apparatus. The portable communication terminal includes a component kind selection unit for capturing at least one or more selected label component kinds, a content information capture unit for capturing content information in accordance with each component kind, a printing data creation unit for creating printing data based on each content information, and a terminal-side short-distance wireless communication unit for transmitting printing data by short-distance wireless communication. Also, the label printing apparatus includes a label printing unit for creating a label based on printing data received by short-distance wireless communication.

### CROSS-REFERENCE TO RELATED APPLICATION

This application claims, under 35 USC 119, priority of Japanese Application No. 2005-378066 filed Dec. 28, 2005.

### BACKGROUND OF THE INVENTION

The present invention relates to a label printing system and a label printing method, being applicable to a label printing system and a label printing method, for example, in which a portable communication terminal enabling data communication is used as an input tool, and in which a label printing apparatus receives by wireless and prints label data created in the portable communication terminal.

In a conventional label printing apparatus, an operating unit provided integrally with the apparatus or a personal computer or the like connected via a cable is used as an input unit, and label printing is performed based on information inputted via such a unit.

Also, in the conventional label printing apparatus, not only letter information but also information including pictograms and images can be printed on a label. In such a case, bitmap data for pictograms and images etc. is stored in the apparatus in advance, and the label printing apparatus performs label printing based on the bitmap data, or image data is converted into bitmap data on a personal computer connected thereto, and the label printing apparatus performs label printing based on the converted bitmap data.

Meanwhile, there is provided a technique in which a portable terminal enabling data communication via a network, as typified by a mobile phone, is used to print information acquired from an information provision apparatus (server) by a printer (Patent Document 1: Japanese Patent Laid-Open No. 2003-167695).

For example, Patent Document 1 discloses a system in which a user uses a portable terminal to clearly print not only lyrics of a popular song and so on but also image information such as a singer's photo and its musical score, in which a printer having received a printing request from the portable terminal requests high-definition image data to the server and prints the image. By doing so, a clearer (higher-definition) image than one displayed on the portable terminal can be outputted.

In recent years, entities such as corporations, for example, use characters, image marks, promo words, etc. to attempt to enhance the image of the entities themselves or their commercial products, services, etc. Consumers collect goods on which these characters etc. are used, and there is a demand for labels to which these characters etc. are attached.

Such a character etc. tends to be temporarily in fashion. Thus, when the conventional technique shown in Patent Document 1 is used, image data for constituting the character etc. needs to be highly accurate, and thus it takes long time to develop it, which makes it difficult to easily prepare image data for the character etc. currently in fashion.

Also, even if image data for the character etc. has been prepared successfully, its label design may tend to be fixed in order to secure repeatability of the character etc., or it may be difficult to rapidly keep up with characters etc. produced successively. Thus, it is impossible to perform unique label printing using the latest character etc. that a user desires.

Further, with a trend of multi-function of a portable communication terminal typified by a mobile phone, there is a demand for printing, on a label, image data obtained using a digital camera built therein or downloaded through a network. There is also a demand for using the portable communication terminal as an operating tool for a label printing apparatus.

### BRIEF SUMMARY OF THE INVENTION

It is an object of the present invention to enable easy printing of various components including not only letter information but also images such as photos and characters on a label by using a portable communication terminal that a user can carry as an input tool or an operating tool for label printing.

According to the present invention, there is provided a label printing system comprising a portable communication terminal and a label printing apparatus for printing a printing image on a tape to create a label, wherein (1) the portable communication terminal includes (1-1) a component kind selection unit for capturing at least one or more selected component kinds constituting a design of the label; (1-2) a content information capture unit for capturing inputted content information in accordance with the selected component kinds; (1-3) a printing data creation unit for creating printing data based on each content information; and (1-4) a terminal-side short-distance wireless communication unit for transmitting the created printing data to the label printing apparatus by short-distance wireless communication, and wherein (2) the label printing apparatus includes (2-1) an apparatus-side short-distance wireless communication unit for receiving the printing data transmitted from the portable communication terminal by short-distance wireless communication; and (2-2) a label printing unit for printing a printing image based on the received printing data on a tape to create a label. Accordingly, by using a portable communication terminal as an input tool for label printing, it is possible to print various components on a label easily.

According to the present invention, there is also provided a label printing system comprising a portable communication terminal, a label printing apparatus for printing a printing image on a tape to create a label, and an information provision apparatus, wherein (1) the portable communication terminal includes (1-1) a component kind selection unit for capturing at least one or more selected component kinds constituting a design of the label; (1-2) a content information capture unit for capturing inputted content information in accordance with the selected component kinds; (1-3) a content information request unit for, in a case where the component kind selection unit has captured at least one or more selected specific component kinds, requesting the information provision apparatus to download content information in accordance with each of specific component kinds; (1-4) a printing data creation unit for creating printing data based on the content information captured by the content information capture unit and/or the content information acquired as a result of downloading from the information provision apparatus requested by the content information request unit; and (1-5) a terminal-side short-distance wireless communication unit for transmitting the created printing data by short-distance wireless communication, wherein (2) the information provision apparatus includes (2-1) a content information storage unit for storing content information in accordance with specific component kinds constituting a design of the label; and (2-2) a communication unit for transmitting content information in accordance with specific component kinds that have been requested to be downloaded by the portable communication terminal to the portable communication terminal, and wherein (3) the label printing apparatus includes (3-1) an apparatus-side short-distance wireless communication unit for receiving the printing data transmitted from the portable communication terminal by short-distance wireless communication; and (3-2) a label printing unit for printing a printing image based on the received printing data on a tape to create a label. Accordingly, by using a portable communication terminal as an input tool for label printing, it is possible to print various components on a label easily.

According to the present invention, there is further provided a label printing system comprising a portable communication terminal, a label printing apparatus for printing a printing image on a tape to create a label, and an information provision apparatus, wherein (1) the information provision apparatus includes (1-1) a printing operation control program provision unit for providing a printing operation control program for giving commands for operations of the label printing apparatus, wherein (2) the portable communication terminal includes (2-1) a program acquisition unit for acquiring the printing operation control program from the printing operation control program provision unit; (2-2) an operation command unit for giving commands for operations of the label printing apparatus by execution of the printing operation control program; and (2-3) a terminal-side short-distance wireless communication unit for transmitting operation commands given by the operation command unit to the label printing apparatus by short-distance wireless communication, wherein (3) the label printing apparatus includes (3-1) an apparatus-side short-distance wireless communication unit for receiving printing data transmitted from the portable communication terminal by short-distance wireless communication; and (3-2) a label printing unit for printing a printing image based on the received printing data on a tape to create a label. Accordingly, by using a portable communication terminal as an operating tool, it is possible to give commands for operations of a label printing apparatus.

According to the present invention, there is still further provided a label printing method in a system comprising a portable communication terminal and a label printing apparatus for printing a printing image on a tape to create a label, wherein (1) the portable communication terminal includes (1-1) a component kind selection step of capturing at least one or more selected component kinds constituting a design of the label; (1-2) a content information capture step of capturing inputted content information in accordance with the selected component kinds; (1-3) a printing data creation step of creating printing data based on the content information; and (1-4) a terminal-side short-distance wireless communication step of transmitting the created printing data to the label printing apparatus by short-distance wireless communication, and wherein (2) the label printing apparatus includes (2-1) an apparatus-side short-distance wireless communication step of receiving the printing data transmitted from the portable communication terminal by short-distance wireless communication; and (2-2) a label printing step of printing a printing image based on the received printing data on a tape to create a label. Accordingly, by using a portable communication terminal as an input tool for label printing, it is possible to print various components on a label easily.

According to the present invention, there is still further provided a label printing method in a system comprising a portable communication terminal, a label printing apparatus for printing a printing image on a tape to create a label, and an information provision apparatus, wherein (1) the portable communication terminal includes (1-1) a component kind selection step of capturing at least one or more selected component kinds constituting a design of the label; (1-2) a content information capture step of capturing inputted content information in accordance with the selected component kinds; (1-3) a content information request step of, in a case where at least one or more selected specific component kinds has been captured in the component kind selection step, requesting the information provision apparatus to download content information in accordance with the specific component kinds; (1-4) a printing data creation step of creating printing data based on the content information captured in the content information capture step and/or the content information acquired as a result of downloading from the information provision apparatus in the content information request step; and (1-5) a terminal-side short-distance wireless communication step of transmitting the created printing data to the label printing apparatus by short-distance wireless communication, wherein (2) the information provision apparatus includes (2-1) a content information storage unit for storing content information in accordance with specific component kinds constituting a design of the label; and (2-2) a communication step of transmitting content information in accordance with specific component kinds that have been requested to be downloaded by the portable communication terminal to the portable communication terminal, and wherein (3) the label printing apparatus includes (3-1) an apparatus-side short-distance wireless communication step of receiving the printing data transmitted from the portable communication terminal by short-distance wireless communication; and (3-2) a label printing step of printing a printing image based on the received printing data on a tape to create a label. Accordingly, by using a portable communication terminal as an input tool for label printing, it is possible to print various components on a label easily.

According to the present invention, there is still further provided a label printing method in a system comprising a portable communication terminal, a label printing apparatus for printing a printing image on a tape to create a label, and an information provision apparatus, wherein (1) the information provision apparatus includes (1-1) a printing operation control program provision step of providing a printing operation control program for giving commands for operations of the label printing apparatus, wherein (2) the portable communication terminal includes (2-1) a program acquisition step of acquiring the printing operation control program; (2-2) an operation command step of giving commands for operations of the label printing apparatus by execution of the printing operation control program; and (2-3) a terminal-side short-distance wireless communication step of transmitting given operation commands to the label printing apparatus by short-distance wireless communication, wherein (3) the label printing apparatus includes (3-1) an apparatus-side short-distance wireless communication step of receiving printing data transmitted from the portable communication terminal by short-distance wireless communication; and (3-2) a label printing step of printing a printing image based on the received printing data on a tape to create a label. Accordingly, by using a portable communication terminal as an operating tool, it is possible to give commands for operations of a label printing apparatus.

### BRIEF DESCRIPTION OF THE DRAWINGS

FIG. 1 is a configuration diagram showing an entire configuration of a label printing system according to a first embodiment.

FIG. 2 is a functional block diagram showing an internal configuration of a portable terminal according to the first embodiment.

FIG. 3 is a functional block diagram explaining functions effected by execution of a printing data creation program in the portable terminal according to the first embodiment.

FIG. 4 is a functional block diagram showing an internal configuration of a label printing apparatus according to the first embodiment.

FIG. 5 is a sequence diagram showing processing in the label printing system according to the first embodiment.

FIG. 6 is an image diagram showing an example of an input screen for input information according to the first embodiment.

FIG. 7 is a flowchart showing input information capture processing according to the first embodiment.

FIGS. 8A and 8B are diagrams explaining an information input pattern according to the first embodiment (1).

FIGS. 9 A to 9C are diagrams explaining an information input pattern according to the first embodiment (2).

FIGS. 10A and 10B are diagrams explaining an information input pattern according to the first embodiment (3).

FIG. 11 shows an example of a data format for printing data according to the first embodiment.

FIG. 12 is a configuration diagram showing an internal hardware configuration of an information provision apparatus according to a second embodiment.

FIG. 13 is a functional block diagram showing functions of an information provision apparatus according to the second embodiment.

FIG. 14 is a block diagram showing an internal configuration of a portable terminal according to a third embodiment.

FIG. 15 is a functional block diagram explaining functions effected by execution of a printing operation control program in the portable terminal according to the third embodiment.

FIG. 16 is a functional block diagram showing an internal configuration of a label printing apparatus according to the third embodiment.

FIG. 17 is a sequence diagram showing processing in a label printing system according to the third embodiment.

### DESCRIPTION OF THE PREFERRED EMBODIMENTS

### (A) First Embodiment

Hereinafter, a first embodiment of a label printing system and a label printing method according to the present invention will be described with reference to the drawings.

(A-1) Configuration of the First Embodiment

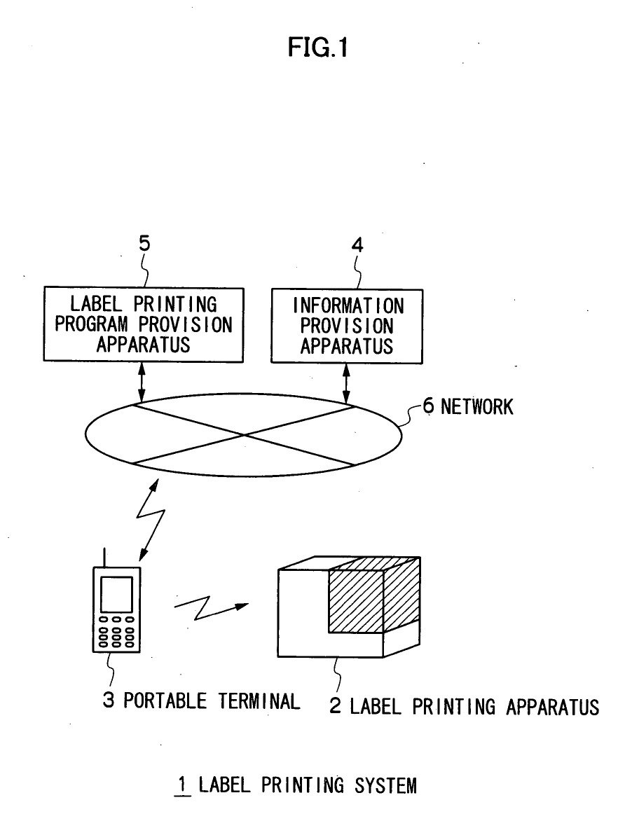

FIG. 1 is an entire configuration diagram showing a configuration of a label printing system according to the present embodiment.

As shown in FIG. 1, a label printing system 1 according to the present embodiment at least has a label printing apparatus 2, a portable terminal 3, an information provision apparatus 4, and a label printing program provision apparatus 5.

Also, in the present embodiment, a network 6 is assumed to be a communication network typified by the Internet, for example, but various types of networks are applicable as long as data communication is enabled through them. Each of the networks may be in wired or wireless configuration, or combination of these, and may be a private or public network.

The portable terminal 3 is a portable wireless communication terminal enabling data communication through the network 6 and is exemplified by a mobile phone, a PDA, a portable game terminal, a PHS terminal, a notebook personal computer having a wireless communication function, and so on. It is noted that a mobile phone is assumed in the present embodiment.

In the present embodiment, the portable terminal 3 functions as an input tool for label printing processing.

The portable terminal 3 is adapted to download a printing data creation program for creating printing data from the label printing program provision apparatus 5 through the network 6 and execute the printing data creation program thereon to create printing data.

By executing the printing data creation program on the portable terminal 3 and creating printing data, a user can create desired label information easily on the portable terminal 3 that the user usually uses.

Also, the portable terminal 3 enables the user who performs label printing to download frame information that he/she desires from the information provision apparatus 4 via the network 6.

It is noted that the frame information consists of bitmap data for characters, promo words, marks, emblems, pictures or figures, etc., used for corporations, goods, services, and the like, is label component information that is data provided around the external sides (upper, lower, left and right sides) of an entire letter string, and is information stored in the information provision apparatus 4.

Further, the portable terminal 3 is adapted to give a printing request to the label printing apparatus 2 and send created printing data to the label printing apparatus 2 by short-distance wireless communication.

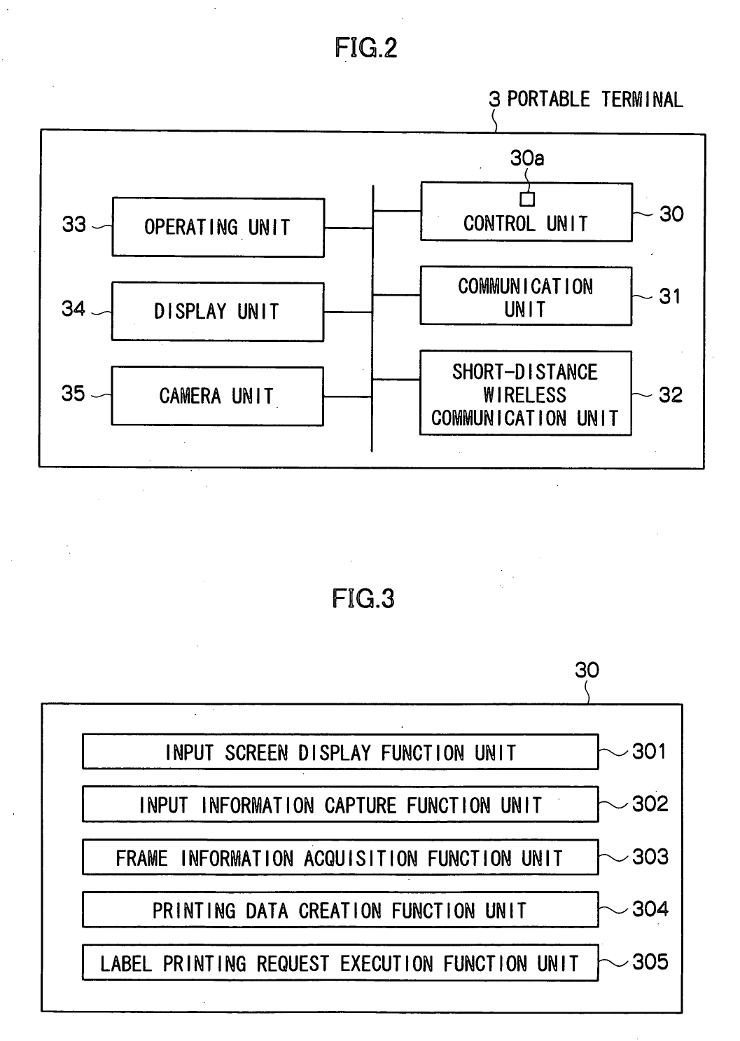

FIG. 2 is a block diagram showing a configuration of the portable terminal 3. As shown in FIG. 2, the portable terminal 3 according to the present embodiment at least has a control unit 30, a communication unit 31, a short-distance wireless communication unit 32, an operating unit 33, and a display unit 34, and the portable terminal 3 has a camera unit 35 as well in the present embodiment.

The control unit 30 is adapted to control functions of the portable terminal 3. The control unit 30 has, for example, a CPU, a ROM, a RAM, etc., in which the CPU regards the RAM as a working area and executes a processing program stored in the ROM by using data stored in the ROM and RAM that are needed for the processing, to effect functions of the portable terminal 3.

In the present embodiment, when the control unit 30 receives a request for creating and printing a label from the user through the operating unit 33, it downloads a printing data creation program 30a through the communication unit 31 so as to enable execution of the printing data creation program 30a.

It is noted that the printing data creation program 30a is a program that is executable on the platform of the portable terminal 3, such as a Java® program, and that can be provided through the network 6.

FIG. 3 is a functional block diagram showing functions of the printing data creation program 30a to be executed in the control unit 30.

As shown in FIG. 3, the control unit 30 executes the printing data creation program 30a to function as an input screen display function unit 301, an input information capture function unit 302, a frame information acquisition function unit 303, a printing data creation function unit 304, and a label printing request execution function unit 305.

The input screen display function unit 301 functions to display, on the display unit 34, an input screen for capturing input information needed for printing data creation. The input screen to be displayed thereon is adapted to allow inputting of, for example, text information and has, for example, selection sections for letter information, photo information, frame information, or other information to enable selection of a component of a label and input sections for capturing specific contents.

The input information capture function unit 302 functions to capture input information inputted by the user through the input screen displayed on the display unit 34.

The frame information acquisition function unit 303 functions to allow the user to download frame information registered in the information provision apparatus 4 from the information provision apparatus 4 through the communication unit 31.

The printing data creation function unit 304 functions to create printing data to be printed on a label from information that forms the label (e.g., letter information (text information), photo information, frame information, or other information) inputted and captured through the input screen. The printing data creation function unit 304 can also determine the attributes, such as the font style, the font type, and whether horizontal ruled lines are displayed, to be available when inputted text information is printed on the label, and create printing data including this attribute information.

The label printing request execution function unit 305 functions to send a label printing request and the printing data to the label printing apparatus 2 through the short-distance wireless communication unit 32 in response to the user's operation.

Meanwhile, the control unit 30 further executes a wireless communication function in the communication unit 31, a short-distance wireless communication function in the short-distance wireless communication unit 32, an input/output control function through the operating unit 33 and the display unit 34, etc.

The communication unit 31 is adapted to perform wireless communication in accordance with a predetermined communication protocol under control of the control unit 30. In the present embodiment, the communication unit 31 receives the printing data creation program 30a from the label printing program provision apparatus 5 and receives frame information from the information provision apparatus 4 through the network 6.

The short-distance wireless communication unit 32 is adapted to perform short-distance wireless communication in accordance with a predetermined communication protocol under control of the control unit 30. The short-distance wireless communication unit 32 performs short-distance wireless communication with the label printing apparatus 2 to request label printing or send printing data to the label printing apparatus 2.

It is noted that the communication method for the short-distance wireless communication is not limited to a specific method, but an IrDA-standard infrared communication, Bluetooth®, Zigbee®, etc. are applicable. Also, the modulation method is not limited to a specific one.

The operating unit 33 corresponds to, for example, a numeric keypad or a letter input keypad and is adapted to be operated by the user while he/she looks at the screen displayed on the display unit 34. The display unit 34 is adapted to display a predetermined display screen thereon under control of the control unit 30, and particularly in the present embodiment, it is adapted to display the input screen for printing data.

The camera unit 35 is not an essential component, but is a digital camera built in a mobile phone or the like. Photo information captured by the camera unit 35 may also be an object to be printed on a label.

Next, the label printing apparatus 2 is adapted to temporarily store printing data wirelessly sent from the portable terminal 3 by short-distance wireless communication and print it on a tape loaded therein based on the printing data.

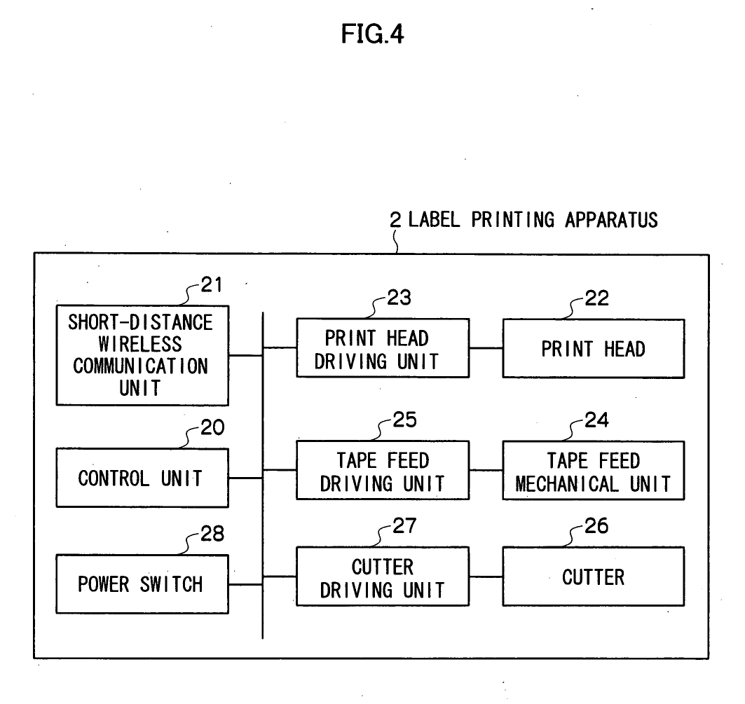

FIG. 4 is a block diagram showing an internal configuration of the label printing apparatus 2. As shown in FIG. 4, the label printing apparatus 2 at least has a control unit 20, a short-distance wireless communication unit 21, a print head 22, a print head driving unit 23, a tape feed mechanical unit 24, a tape feed driving unit 25, a cutter 26, a cutter driving unit 27, and a power switch 28.

The control unit 20 is adapted to control functions of the label printing apparatus 2. The control unit 20 has, for example, a CPU, a ROM, a RAM, etc., in which the CPU regards the RAM as a working area and executes a processing program stored in the ROM by using data stored in the ROM and RAM that are needed for the processing, to effect functions of the label printing apparatus 2. In the present embodiment, the control unit 20 at least executes a control function for controlling short-distance wireless communication with the portable terminal 3, a printing function for printing on a tape based on printing data received by the short-distance wireless communication, and a tape feed function for feeding the tape in accordance with printing processing.

The short-distance wireless communication unit 21 is adapted to perform short-distance wireless communication in accordance with a predetermined communication protocol under control of the control unit 20. The short-distance wireless communication unit 21 performs short-distance wireless communication with the portable terminal 3, demodulates wireless signals sent from the portable terminal 3, restores printing data needed for label printing (signals sent from the portable terminal 3) based on the demodulated signals, and gives the printing data to the control unit 20.

It is noted that the communication method for the short-distance wireless communication is not limited to a specific method, but an IrDA-standard infrared communication, Bluetooth®, Zigbee®, etc. are applicable.

The print head 22 is for example a thermal head that transfers ink of the ink ribbon on the tape. The print head driving unit 23 is adapted to drive each heating element of the print head 22 appropriately under control of the control unit 20.

The tape feed mechanical unit 24 is a mechanism to feed or stop the tape and the ink ribbon in a not shown tape cassette loaded in the label printing apparatus 2. Meanwhile, the tape is fed from the inside of the tape cassette to the outside, while the ink ribbon is fed within the tape cassette. (Note that the position opposed to the print head 22 has a window.)

The tape feed driving unit 25 is adapted to drive the tape feed mechanical unit 24 under control of the control unit 20.

The cutter driving unit 27 is adapted to drive the cutter 26 under control of the control unit 20 to cut the tape.

Meanwhile, the cutter driving unit 27 and the cutter 26 have various modes such as one in which a printed tape is automatically cut and one in which four corners of a cut tape is cut in a round shape.

The power switch 28 is a switch to turn on the power of the label printing apparatus 2.

The information provision apparatus 4 is a server that provides frame information to one or more portable terminals 3 in response to a request from it/them through the network 6 and stores therein plural kinds of frame information in advance.

Frame information stored in the information provision apparatus 4 is bitmap data as large as one or more label sizes that can be printed by a preset label printing apparatus 2. Accordingly, it is possible to prepare even a character temporarily in fashion and a latest character rapidly in a short period without the need for preparing highly accurate printing data, and cost reduction and stock risk reduction can be achieved.

Meanwhile, although a case where uni-color (black) bitmap data is prepared as frame information is explained in the present embodiment, frame information consisting of two or more colors may be prepared if possible.

The label printing program provision apparatus 5 is a server that provides the printing data creation program 30a to one or more portable terminals 3 in response to a request from it/them through the network 6.

Meanwhile, although the information provision apparatus 4 and the label printing program provision apparatus 5 are shown as systems physically separated from each other in the present embodiment, they may be a united system.

(A-2) Operation of the First Embodiment

The operation of the label printing system 1 according to the present embodiment will be explained with reference to the drawings.

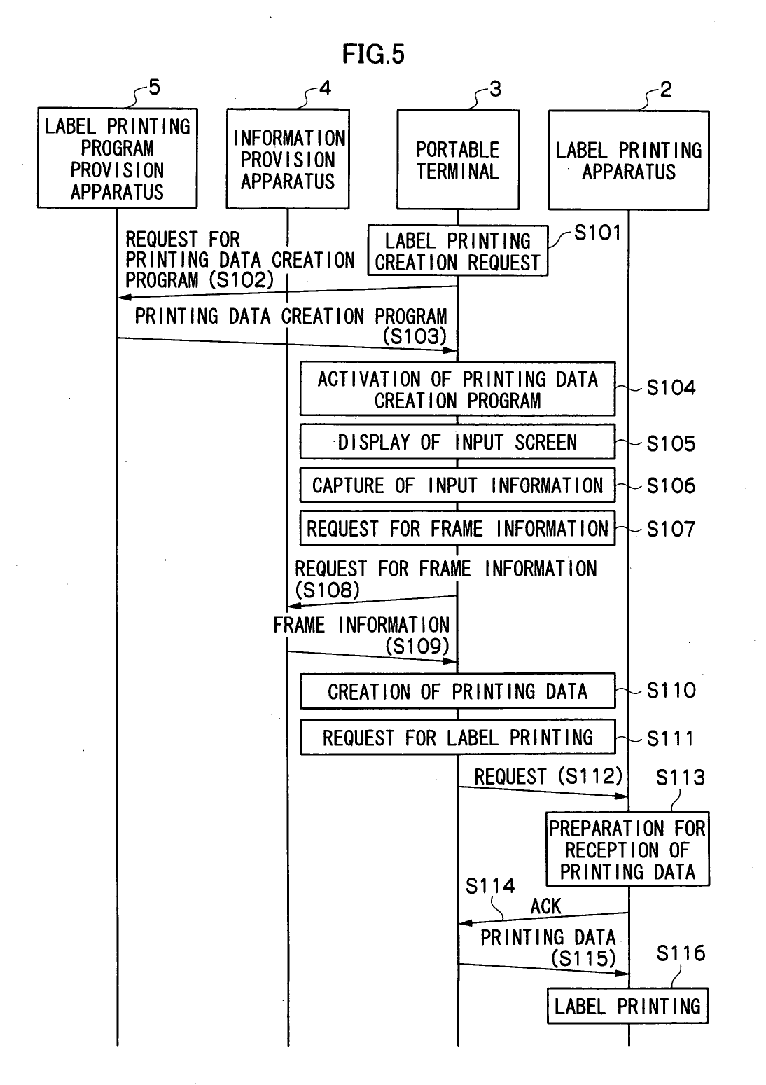

FIG. 5 is a sequence diagram showing label printing processing in the label printing system 1 according to the present embodiment. It is noted that FIG. 5 shows a case where frame information is a component of the label design.

The user who wishes to create a label that he/she desires operates his/her own portable terminal 3 as an input tool for the label printing apparatus 2 to create printing data for label printing and send the printing data to the label printing apparatus 2 so that the label printing apparatus 2 performs label printing.

First, the user uses the operating unit 33 of the portable terminal 3 to give a label printing creation request by a predetermined operation (S101).

At this time, in the present embodiment, the printing data creation program 30a for creating printing data for label printing is downloaded from the label printing program provision apparatus 5 to the portable terminal 3. Thus, the portable terminal 3 accesses the label printing program provision apparatus 5 on the network 6 by the user's operation to request downloading of the printing data creation program (S102).

At this time, the label printing program provision apparatus 5 may perform predetermined user authentication processing. Various methods for this user authentication processing may be applied as long as they can identify the user as a registered user.

When the request for downloading the printing data creation program is given from the portable terminal 3 to the label printing program provision apparatus 5, the requested printing data creation program 30a is given from the label printing program provision apparatus 5 to the portable terminal 3 and is downloaded on the portable terminal 3 (S103).

As described above, as for the printing data creation program 30a, a program that is executable on the portable terminal 3, such as a Java® program, can be applied, and it can utilize a system embedded in the existing portable terminal 3.

When the printing data creation program 30a is downloaded on the portable terminal 3, the printing data creation program 30a is activated by the user's operation (S104).

Meanwhile, in the present embodiment, the aforementioned request for the printing data creation program (S102) and the downloading of the printing data creation program (S103) is performed each time of printing data creation. However, the printing data creation program may be stored in a memory unit (for example, a writable non-volatile ROM) built in the portable terminal 3 at the first-time printing data creation so that, in the second- or subsequent-time printing data creation, the printing data creation program stored in the memory unit may be called in the RAM or the like arbitrarily based on the label printing creation request (S101), and the program may be activated (S104) automatically.

When the printing data creation program 30a is activated, the input screen needed for label creation is displayed on the display unit 34 (S105). The user operates the operating unit 33 while looking at the input screen displayed on the display unit 34 and inputs information constituting the desired label design (S106).

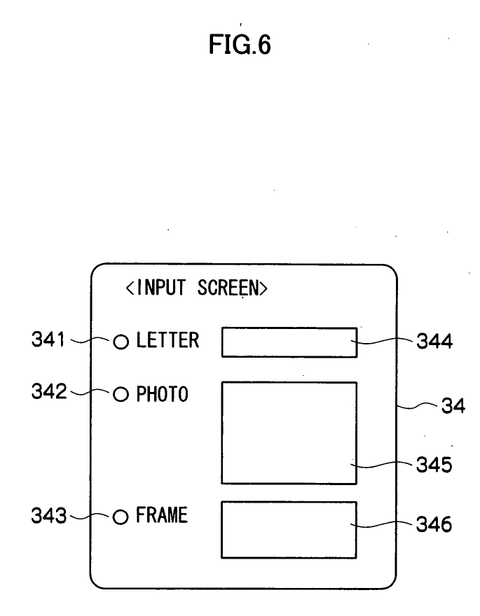

FIG. 6 is an image diagram showing an example of the input screen displayed on the display unit 34. As shown in FIG. 6, the input screen example in the present embodiment at least has component selection sections 341 to 343 for selecting a component of the label design and component input sections 344 to 346.

In the present embodiment, the components of the label design are letter information (text input information), photo information, and frame information. Thus, the component selection sections 341 to 343 include a letter information selection section 341 for selecting text input, a photo information selection section 342 for selecting photo information, and a frame information selection section 343 for selecting frame information, as shown in FIG. 6. Also, the component input sections 344 to 346 include a letter information input section 344, a photo information input section 345, and a frame information input section 346, each of which will allow input of each input information if its corresponding component selection section 341, 342 or 343 is selected.

Also, in the present embodiment, the label design can be constituted by arbitrarily selected combination of the letter information, photo information and frame information.

When the frame information is selected as a component at the time of selection of a component of the label design and input of its specific contents by the user's operation in S106, the portable terminal 3 that executes the printing data creation program 30a accesses the information provision apparatus 4 that stores frame information, requests frame information that the user desires (S108), downloads the frame information, and sets it as input information (S109).

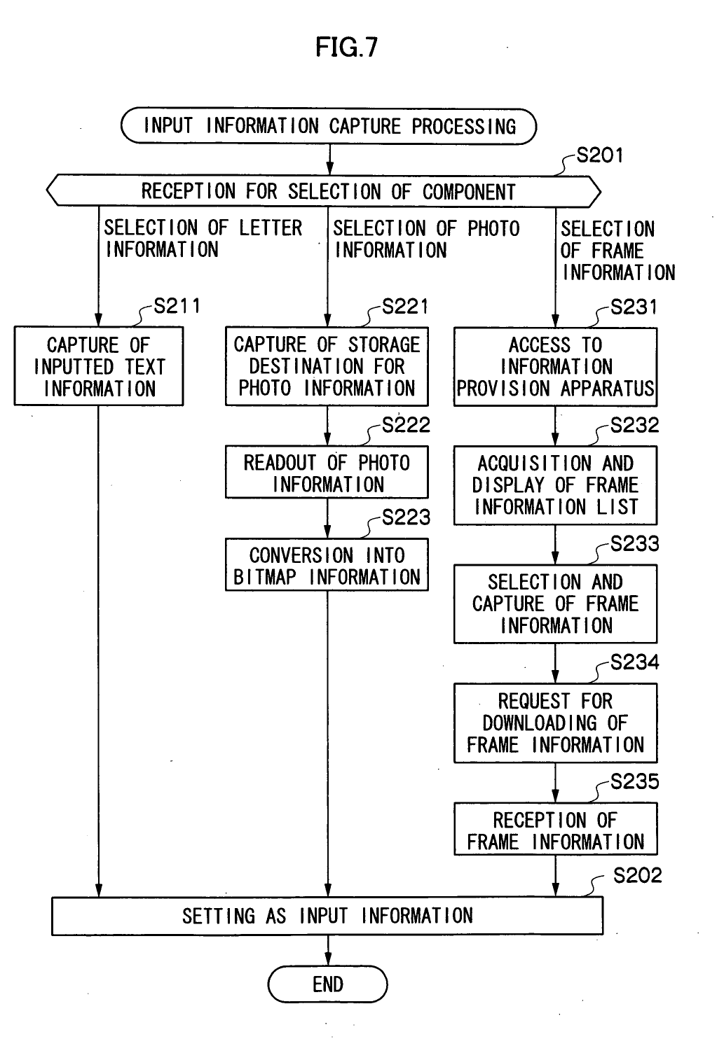

Now, the processing on the portable terminal 3 from S105 to S109 in FIG. 5 will be described in detail with reference to the flowchart in FIG. 7.

In FIG. 7, the display unit 34 firstly displays a predetermined input screen thereon and allows the user to select a component of the label design (S201), and the user selects a label design component and inputs its specific contents.

As described above, the user can herein select letter information that is text input information, photo information stored in the portable terminal 3, or frame information stored in the information provision apparatus 4 as a design component.

In a case where the user wishes to select letter information, the user operates the operating unit 33 to select the letter information selection section 341 on the display unit 34. Then, the control unit 30 of the portable terminal 3 enables text input in the letter information input section 344 and captures the inputted text information (S211). In the portable terminal 3, the captured text information is set as input information (S202).

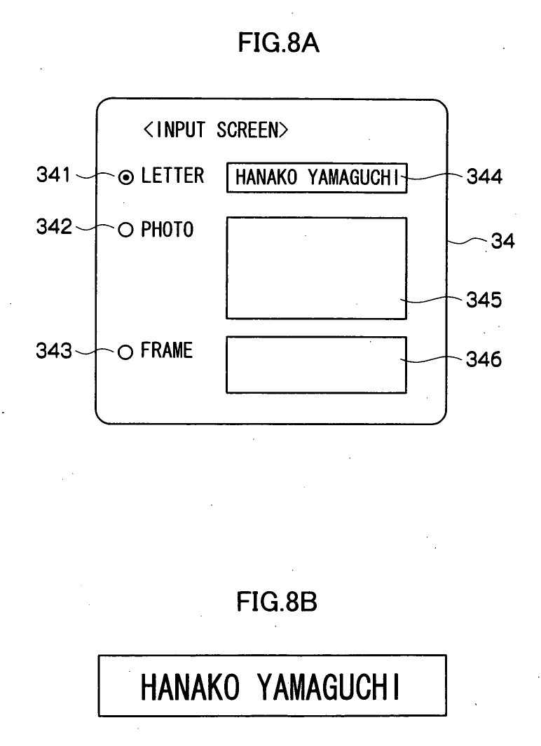

For example, the processing image in this case is explained in FIGS. 8A and 8B. When the letter information selection section 341 is selected by the user as in FIG. 8A, text input in the letter information input section 344 is enabled, and the user can input information for label printing (e.g., “Hanako Yamaguchi” in FIG. 8A) by operating the operating unit 33.

Meanwhile, as for letter information, various kinds of information can be applied as long as it is inputted as text information. For example, contents in the phone book, schedules, e-mail contents, e-mail addresses, memo, bookmarks, URLs, etc. stored in the portable terminal 3 may be inputted.

Also, in a case where the user wishes to select photo information stored in the portable terminal 3, the user operates the operating unit 33 to select the photo information selection section 342 on the display unit 34. Then, the control unit 30 requests the user to input a storage destination for photo information for label printing and captures the storage destination for the photo information (S221). Then, the photo information stored is read out from the captured storage destination (S222). When the photo information is read out, it is converted into bitmap information that will be printed on a label in the label printing apparatus 2 based on the photo information (S223), and the bitmap information for the photo information is set as input information (S202).

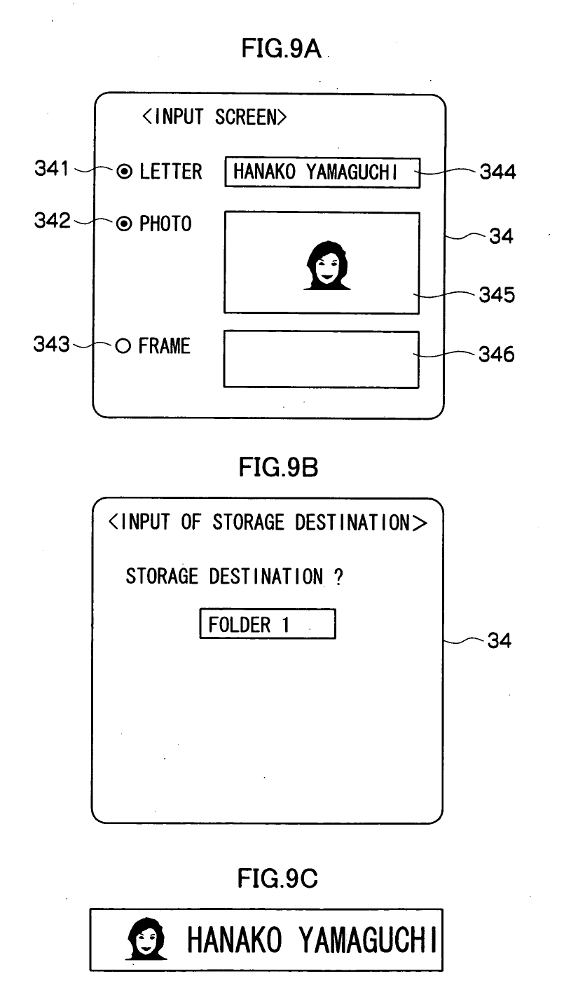

For example, the processing image in this case is explained in FIGS. 9A to 9C. The photo information selection section 342 is selected by the user as in FIG. 9A. It is noted that the letter information selection section 341 is also selected in FIG. 9A. When the photo information selection section 342 is selected, the display unit 34 displays an input screen for a storage destination for photo information as in FIG. 9B under control of the control unit 30 and prompts the user to input a storage destination for photo information. Then, the control unit 30 reads out photo information based on the inputted storage destination information (“Folder 1” in FIG. 9B) for photo information, converts the photo information into bitmap information, and sets the bitmap information as input information.

Further, in a case where the user wishes to select frame information stored in the information provision apparatus 4, the user operates the operating unit 33 to select the frame information selection section 343 on the display unit 34. Then, the control unit 30 accesses the information provision apparatus 4, acquires frame information, and sets it as input information as follows.

When frame information is selected by the user, the control unit 30 controls the communication unit 31 and accesses the information provision apparatus 4 that stores frame information (S231).

When the information provision apparatus 4 is accessed, list information for frame information stored in the information provision apparatus 4 is transmitted to the portable terminal 3, and the portable terminal 3 displays the list information on the display unit 34 (S232).

The user looks at the list information for frame information displayed on the display unit 34 and selects desired frame information, and the control unit 30 captures the selection (S233). The control unit 30 requests the information provision apparatus 4 to download the frame information selected by the user (S234).

The information provision apparatus 4 received the request for the frame information from the portable terminal 3 transmits the frame information requested to be downloaded to the portable terminal 3, and the portable terminal 3 receives the frame information (S235). The control unit 30 sets the received frame information as input information for the label design (S202). By doing so, frame information desired by the user can be downloaded on the portable terminal 3, and the frame information can be set as input information for a component of the label design.

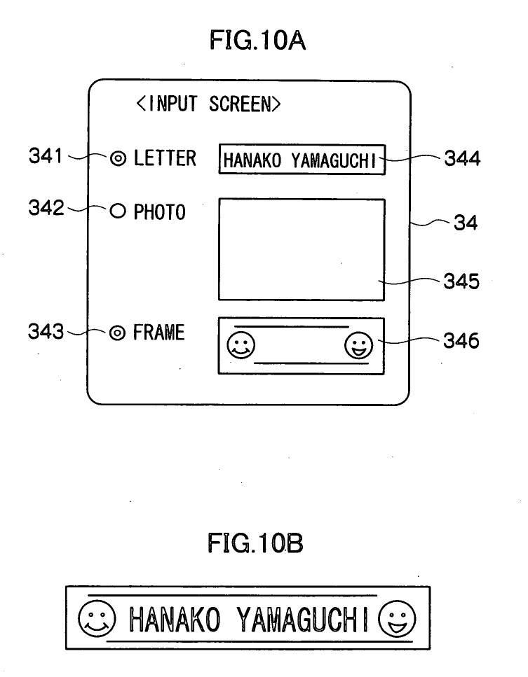

For example, the processing image in a case of setting frame information as input information is explained in FIGS. 10A and 10B. The frame information selection section 343 is selected by the user as in FIG. 10A. It is noted that the letter information selection section 341 is also selected in FIG. 10A. When the frame information selection section 343 is selected, the communication unit 31 accesses the information provision apparatus 4 under control of the control unit 30 and receives list information for frame information stored in the information provision apparatus 4. Also, the display unit 34 displays the received list information thereon under control of the control unit 30 and prompts the user to select one of them. Then, the communication unit 31 requests the information provision apparatus 4 to download frame information selected by the user under control of the control unit 30 and receives the frame information downloaded from the information provision apparatus 4. The control unit 30 sets the received frame information as input information.

Accordingly, it is possible to select a component of the label design by the user's selection and capture input information based on the selection.

Referring back to FIG. 5, when input information has been captured in the portable terminal 3 successfully, printing data for label printing in the label printing apparatus 2 is created in the portable terminal 3 (S110).

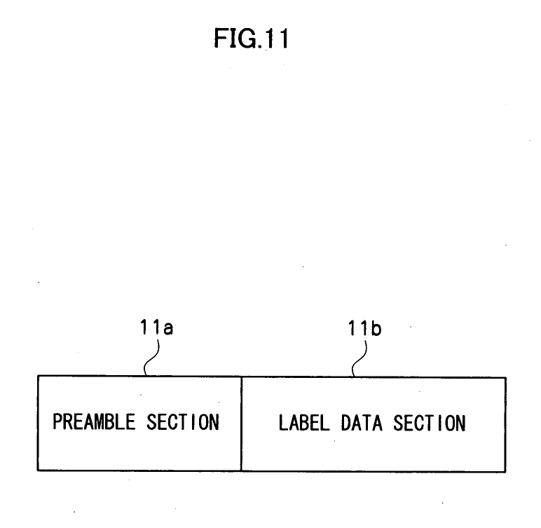

Here, the processing for creating printing data will be described. FIG. 11 shows an example of a data format for printing data. As shown in FIG. 11, the printing data at least has a preamble section 11a and a label data section 11b.

The label data section 11b is data based on input information inputted by the user's operation and is composed of text data that is letter information and/or bitmap data that is photo information or frame information.

At the time of printing data creation, the user can operate the portable terminal 3 to select the font style, font type, tape type, etc. as for text data. In this case, the selection contents are made to be contained in the label data section 11b as attribute information to create printing data.

Meanwhile, in the present embodiment, bitmap data for photo information and frame information is fixed data set previously so that a layout cannot be edited by the user. By disabling data edit, primary data use can be maintained, in which bitmap data stored in the information provision apparatus 4 is appropriately used.

When printing data desired by the user is created in the portable terminal 3, the short-distance wireless communication unit 32, in response to a request operation for label printing by the user (S111), requests label printing to the label printing apparatus 2 under control of the control unit 30 (S112).

The label printing apparatus 2, which has received a label printing request from the portable terminal 3, prepares for reception of printing data, and when it is ready for reception, it sends back an ACK signal to the portable terminal 3 (S113 and S114).

When the ACK signal is received from the label printing apparatus 2, the printing data created in the portable terminal 3 is transmitted to the label printing apparatus 2 by short-distance wireless communication (S115).

When the printing data is transmitted from the portable terminal 3, the label printing apparatus 2 performs label printing based on the received printing data (S116). Accordingly, it is possible to print a label having the label design desired by the user easily.

In one example, in a case where only letter information is selected as in FIG. 8A, the label printing apparatus 2 can print a label constituted by letters inputted by the user as shown in FIG. 8B.

In another example, in a case where photo information and letter information are selected as in FIG. 9A, the label printing apparatus 2 can print a label constituted by combination of a photo and letters selected by the user as shown in FIG. 9C.

In a still alternative example, in a case where frame information and letter information are selected as in FIG. 10A, the label printing apparatus 2 can print a label constituted by combination of frame information and letter information selected by the user as shown in FIG. 10B.

As described above, according to the present embodiment, since frame information such as characters etc. is stored in the information provision apparatus 4 so as to enable downloading on the portable terminal 3, frame information such as characters temporarily in fashion can be prepared easily and can be created as printing data easily.

Also, according to the present embodiment, by utilizing the portable terminal 3 that the user usually uses as an input tool for the label printing apparatus 2, it is possible to create label data and execute label printing easily. In particular, when using a mobile phone, the user can create a “single-line label” easily by input with the user's thumb.

Further, according to the present embodiment, by utilizing a data communication function built in the portable terminal 3, it is possible to acquire applications from the label printing program provision apparatus 5 on the network 6 and give a label printing request to the label printing apparatus 2 easily.

Still further, according to the present embodiment, in addition to the “single-line label” by text input, a label for personal use can be created based on photo information stored in the portable terminal 3 or frame information stored in the information provision apparatus 4.

### (B) Second Embodiment

Next, a second embodiment of a label printing system and a label printing method according to the present invention will be described with reference to the drawings.

In the second embodiment, functions of the information provision apparatus differs from one in the first embodiment, and the entire configuration of the label printing system is the same as one shown in FIG. 1. Thus, the second embodiment is explained with reference to FIG. 1, which is the entire configuration diagram of the first embodiment.

As described above, functions of the information provision apparatus 4 differ in the second embodiment, and thus the functions of the information provision apparatus 4 are explained mainly with reference to the drawings.

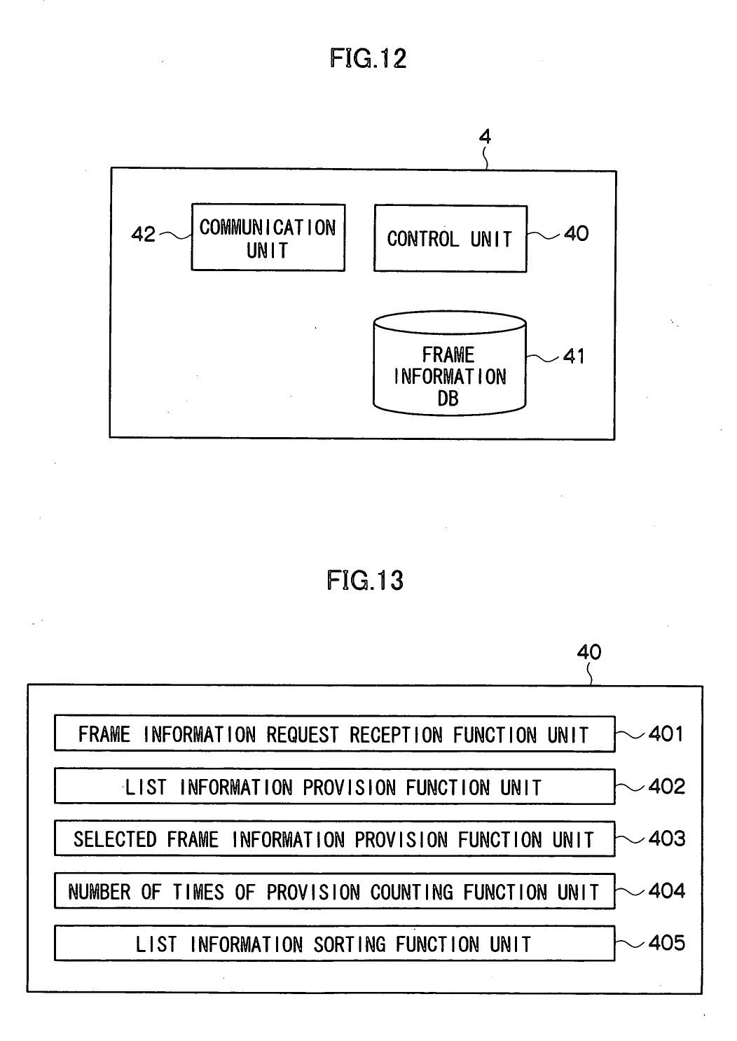

FIG. 12 is a configuration diagram showing an internal hardware configuration of the information provision apparatus 4. As shown in FIG. 12, the information provision apparatus 4 at least has a control unit 40, a frame information database (DB) 41, and a communication unit 42. Meanwhile, the information provision apparatus 4 of the first embodiment has a similar hardware configuration to one shown in FIG. 12.

FIG. 13 is a functional block diagram showing functions to be executed in the control unit 40 of the information provision apparatus 4. As shown in FIG. 13, the control unit 40 at least has a frame information request reception function unit 401, a list information provision function unit 402, a selected frame information provision function unit 403, a number of times of provision counting function unit 404, and a list information sorting function unit 405.

The frame information request reception function unit 401 functions to receive an access from the portable terminal 3 for a request for frame information, the list information provision function unit 402 functions to provide the accessed portable terminal 3 with list information for frame information stored in the frame information DB 41, and the selected frame information provision function unit 403 functions to search frame information requested from the portable terminal 3 from the frame information DB 41 and provide the portable terminal 3 with the frame information.

It is noted that the frame information request reception function unit 401, the list information provision function unit 402, and the selected frame information provision function unit 403 correspond to functions built in the information provision apparatus of the first embodiment.

Meanwhile, since the entire processing of the label printing system 1 of the second embodiment is similar to one explained in the first embodiment shown in FIG. 5, and the basic processing of the information provision apparatus 4, in which it transmits frame information in accordance with a request from the portable terminal 3 for downloading of frame information, is also similar to one in the first embodiment, the explanation of these procedures is omitted.

When the information provision apparatus 4 in the second embodiment provides (downloads) frame information in accordance with a request for downloading of the frame information selected by the portable terminal 3, it counts the number of times of provision of each frame information and sorts list information for frame information based on each count value, as explained below. Then, when another request is made from the portable terminal 3 for downloading of frame information thereafter, the information provision apparatus 4 transmits the sorted list information to the portable terminal 3.

The number of times of provision counting function unit 404 is adapted to count the number of times of provision request from the portable terminal 3 per frame information. By counting the number of times of provision of each frame information such as a character etc., the user can know the popularity of frame information such as a character etc.

The list information sorting function unit 405 is adapted to sort the contents of list information for frame information in a predetermined order based on the result of counting for each frame information by the number of times of provision counting function unit 404.

This sorting order can be changed under a rule set by a system operator and so on. For example, the list contents can be sorted in ascending order of popularity, in ascending order of popularity increase rate within a certain period of time, reversely in descending order of popularity (that is, showing the degree of rareness of a character, etc.), or the like.

Also, the sorting timing can be set by a system operator and so on. For example, the system operator can set one or more timings such as sorting every hour, every several hours, and every day.

Meanwhile, list information creation is not limited to creation of one kind of list information but may include creation of plural kinds of list information based on the counted number of times of provision.

The list information provision function unit 402 will provide list information sorted by the list information sorting function unit 405 to the portable terminal 3 when the portable terminal 3 requests provision next time.

Accordingly, the second embodiment can bring about similar effects to those in the first embodiment.

Also, according to the second embodiment, since the information provision apparatus 4 can count the number of times of provision and create list information in accordance with the counting result, it is possible to provide the user with frame information such as characters, etc. in ascending order of popularity along with the fashion.

### (C) Third Embodiment

Next, a third embodiment of a label printing system and a label printing method according to the present invention will be described with reference to the drawings.

(C-1) Configuration of the Third Embodiment

As the entire configuration of the label printing system in the third embodiment is also the same as one in the first embodiment, the third embodiment is explained with reference to FIG. 1.

The third embodiment is characterized by (1) the label printing program provision apparatus 5 having a printing operation control program for controlling operations required for label printing of the label printing apparatus 2, (2) the portable terminal 3 which downloads the printing operation control program from the label printing program provision apparatus 5 and executes the printing operation control program to control operations of the label printing apparatus 2, and (3) functions and configuration of the label printing apparatus 2.

Thus, hereinafter, the characteristics of the third embodiment are explained mainly, and the explanation of the matters explained in the first embodiment is omitted.

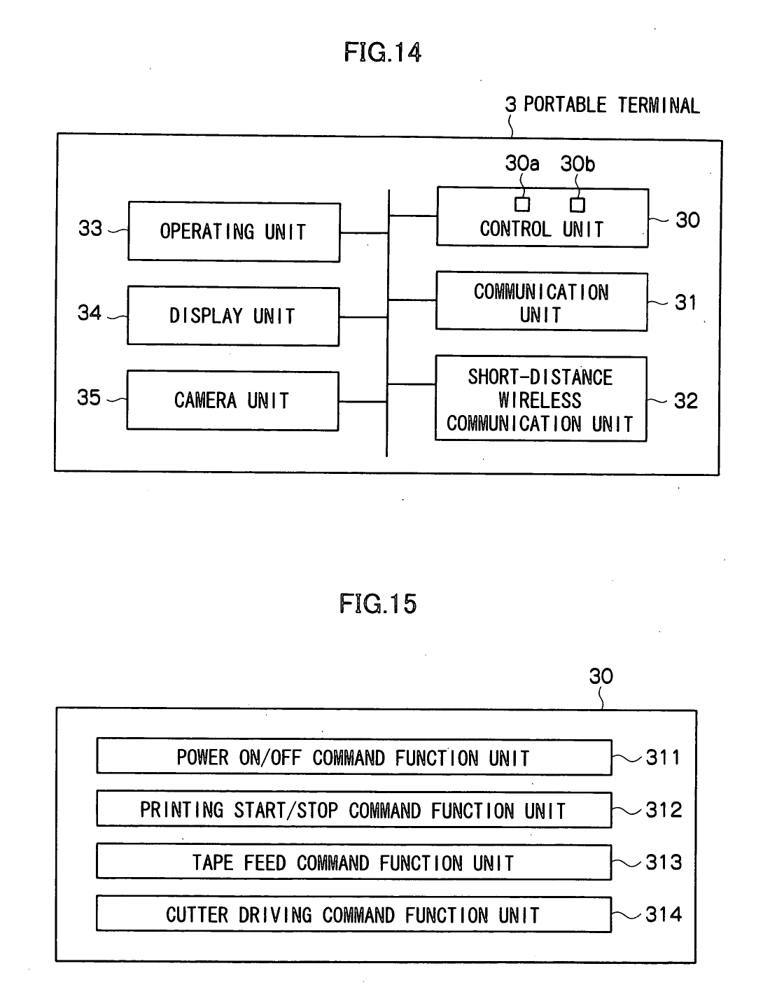

FIG. 14 is a block diagram showing an internal configuration of the portable terminal 3 according to the third embodiment. The differences between the configuration of FIG. 14 and that of the first embodiment of FIG. 2 are at those points where the control unit 30 receives from the label printing program provision apparatus 5 and stores therein a printing operation control program 30b as well, and other components are the same as those in the first embodiment.

As described above, the portable terminal 3 is adapted to request the label printing program provision apparatus 5 to download the printing operation control program 30b and store the printing operation control program 30b received from the label printing program provision apparatus 5 in a writable non-volatile memory unit constituting the control unit 30.

Also, the portable terminal 3 is adapted to activate and execute the stored printing operation control program 30b in response to the user's operation to send commands for label printing operations to the label printing apparatus 2 by short-distance wireless communication.

Thus, the portable terminal 3 can not only create printing data but also control commands for label printing operations such as a command for power on/off of the label printing apparatus 2, a command for printing start or printing stop, a command for tape feed, and a command for cutter driving by utilizing the short-distance wireless communication.

It is noted that the printing operation control program 30b is a program that is executable on the platform of the portable terminal 3, such as a Java® program, just like the printing data creation program 30a.

Also, when the printing operation control program 30b is activated on the portable terminal 3, an input operation screen for giving commands for operations of the label printing apparatus 2 is displayed on the display unit 34 of the portable terminal 3, and the user gives commands for operations of the label printing apparatus 2 through the input operation screen.

FIG. 15 is a functional block diagram showing an example of functions of the printing operation control program 30b to be executed in the control unit 30 of the portable terminal 3.

As shown in FIG. 15, the control unit 30 executes the printing operation control program 30b to function as a power on/off command function unit 311 to turn on/off the power of the label printing apparatus 2, a printing start/stop command function unit 312 to start printing based on printing data or stop printing, a tape feed command function unit 313 to give a command for tape feed as needed, and a cutter driving command function unit 314 to cut a tape after completion of printing.

Meanwhile, the short-distance wireless communication unit 32 of the portable terminal 3 not only has the function explained in the first embodiment but also functions to send user's commands for operations of the label printing apparatus 2 by short-distance wireless communication under control of the control unit 30.

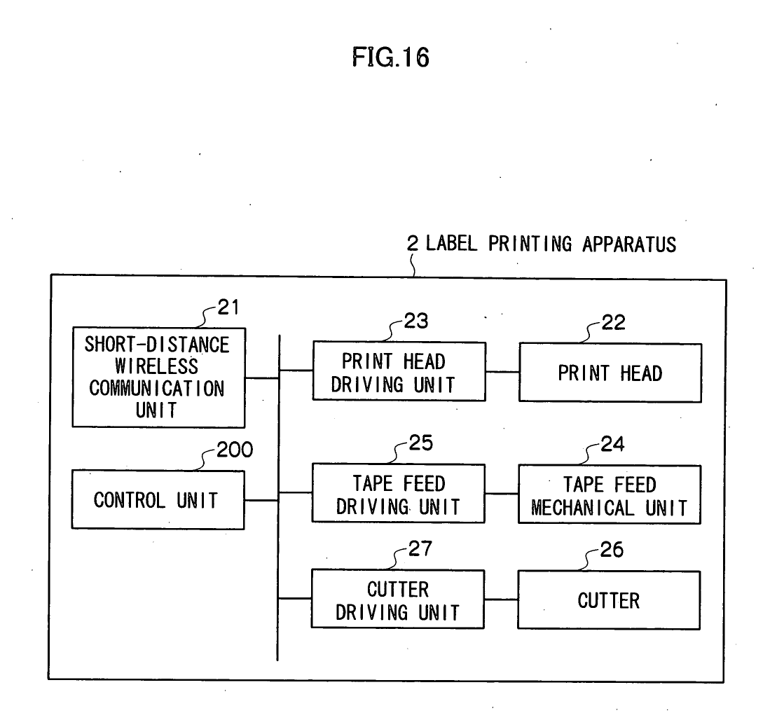

Next, the functions and configuration of the label printing apparatus 2 are explained with reference to FIG. 16. The differences between the label printing apparatus 2 of FIG. 16 and that of the first embodiment of FIG. 4 are at those points where the label printing apparatus 2 has a control unit 200 instead of the control unit 20 and does not have the power switch 28.

In the third embodiment, since the label printing apparatus 2 can be switched on or off in accordance with a power on/off command sent from the portable terminal 3 by short-distance wireless communication, the label printing apparatus 2 does not have to include the power switch 28. By doing so, the configuration size of the label printing apparatus 2 can be reduced, and the production cost can be reduced.

The control unit 200 is adapted to decode a command from the portable terminal 3 based on a reception signal received by the short-distance wireless communication unit 21 and give the command to the print head driving unit 23, the tape feed driving unit 25, or the cutter driving unit 27. By doing so, it is possible to operate the label printing apparatus 2 in accordance with a command from the portable terminal 3.

The label printing program provision apparatus 5 in the third embodiment stores the printing operation control program in advance as described above and is adapted to give the printing operation control program to the portable terminal 3 when receiving the request from the portable terminal 3.

(C-2) Operation of the Third Embodiment

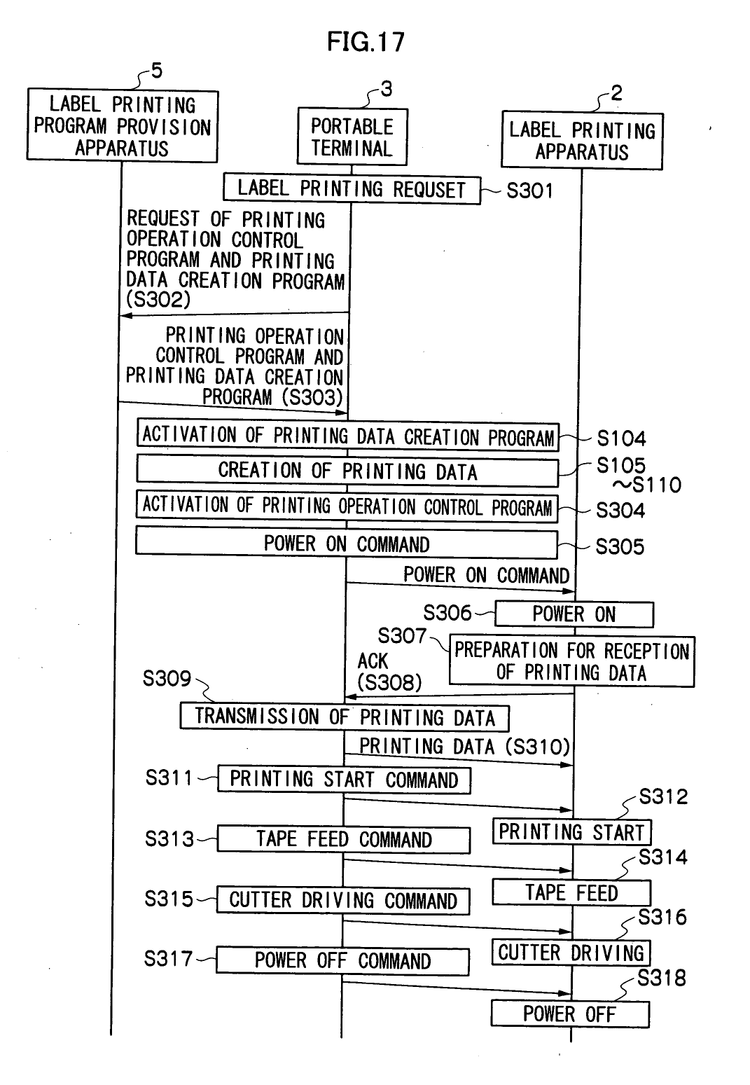

Subsequently, the operation of the label printing system 1 according to the third embodiment will be explained with reference to FIG. 17.

FIG. 17 is a sequence diagram showing label printing processing in the label printing system 1 according to the third embodiment.

First, the user uses the operating unit 33 of the portable terminal 3 to give a label printing request by a predetermined operation (S301).

At this time, in the present embodiment, the portable terminal 3 requests the label printing program provision apparatus 5 to download the printing operation control program 30b as well as the printing data creation program 30a (S302).

When the request for downloading the printing operation control program 30b and the printing data creation program 30a is given from the portable terminal 3 to the label printing program provision apparatus 5, the printing operation control program and the printing data creation program are given from the label printing program provision apparatus 5 to the portable terminal 3 and are downloaded on the portable terminal 3 (S303).

When the printing data creation program 30a is activated on the portable terminal 3, printing data is created in response to the user's operations as explained in the first embodiment (S104 to S110).

Also, when the printing operation control program 30b is activated on the portable terminal 3 (S304), the portable terminal 3 can control operations of the label printing apparatus 2 by utilizing short-distance wireless communication in response to the user's operations.

For example, in FIG. 17, when the user gives a command for power on through the input operation screen (not shown) displayed on the display unit 34, a signal containing the power on command is transmitted from the short-distance wireless communication unit 32 (S305). When the label printing apparatus 2 receives the signal containing the power on command, it turns on its power based on the signal (S306).

When the power is on, and the label printing apparatus 2 is ready for reception of printing data (S307), the label printing apparatus 2 sends back an ACK signal showing the ready state for reception of printing data by short-distance wireless communication (S308).

In the portable terminal 3, printing data is transmitted by short-distance wireless communication in response to the user's operation (S309 and S310). When the user gives a command for printing start after the printing data is given to the label printing apparatus 2, the portable terminal 3 transmits a signal containing the command for printing start to the label printing apparatus 2 by short-distance wireless communication (S311). Then, the label printing apparatus 2 drives the print head driving unit 23 and starts label printing based on the received printing data in accordance with the printing start command (S312).

Meanwhile, if the user wishes to stop printing, the user can stop printing processing of the label printing apparatus 2 that is performing printing by doing a similar step to S311.

Also, in the case of tape feed (without printing) as needed, when the user gives a command for tape feed, the portable terminal 3 transmits a signal containing the command for tape feed to the label printing apparatus 2 by short-distance wireless communication (S313). Then, the label printing apparatus 2 drives the tape feed driving unit 25 and performs tape feed in accordance with the tape feed command (S314).

Further, when the user gives a command for cutter driving, the portable terminal 3 transmits a signal containing the command for cutter driving to the label printing apparatus 2 by short-distance wireless communication (S315). Then, the label printing apparatus 2 drives the cutter driving unit 27 and performs tape cutting by the cutter in accordance with the cutter driving command (S316).

Still further, when the user gives a command for power off, the portable terminal 3 transmits a signal containing the command for power off to the label printing apparatus 2 by short-distance wireless communication (S317). Then, the label printing apparatus 2 turns off its power in accordance with the power off command (S318).

Meanwhile, although the third embodiment has been explained taking as an example a case where the printing data creation program 30a and the printing operation control program 30b are downloaded at the same time, the printing operation control program 30b may be downloaded individually.

Also, in the third embodiment, the printing operation control program 30b is downloaded each time of an operation of the label printing apparatus 2. However, the printing operation control program 30b may be stored in a memory unit (for example, a writable non-volatile ROM) built in the portable terminal 3 at the first-time label printing so that, in the second- or subsequent-time label printing, the printing operation control program 30b stored in the memory unit may be called in the RAM or the like arbitrarily based on the label printing creation request (S301), and the program may be activated (S304) automatically.

Further, in the third embodiment, each command is given independently. However, plural command signals may be transmitted as a result of giving one command.

For example, when a printing command signal is transmitted, printing data is first transmitted (S310) based on a printing data transmission command (S309), and when a signal for completion of printing data reception is transmitted from the label printing apparatus 2, a printing start command (S311) is transmitted immediately, and label printing is started in the label printing apparatus 2 (S312). When a signal for completion of label printing is transmitted from the label printing apparatus 2, a tape feed command (S313) is transmitted immediately (as needed), and tape feed (S314) is performed in the label printing apparatus 2. When a signal for completion of tape feed is transmitted from the label printing apparatus 2, a cutter driving command (S315) is transmitted immediately, and the cutter is driven to cut a tape in the label printing apparatus 2 (S316). In the above manner, sequential procedures of the printing data transmission (S309), the transmission of the printing start command (S311), the transmission of the tape feed command (S313), and the transmission of the cutter driving command (S315) may be executed by only transmission of the printing command signal (one command).

It is noted that the sequence flow shown in FIG. 17 is just an example. The label printing apparatus 2 may perform parallel processing, in which it receives and carries out each interrupting command.

Accordingly, the third embodiment can bring about similar effects to those in the first embodiment.

Also, according to the third embodiment, the portable terminal 3 executes the downloaded printing operation control program 30b such that the portable terminal 3 can be used as an operating tool for the label printing apparatus 2 and remote-control the label printing apparatus 2.

### (D) Other Embodiments

The entire configuration of the label printing system according to the present invention is not limited to one shown in FIG. 1 in the first to third embodiments.

For example, although the information provision apparatus 4 and the label printing program provision apparatus 5 have been shown as different systems from each other in FIG. 1, they may provide the same function. That is, the label printing program provision apparatus 5 may be adapted to provide frame information. Also, even in a case where the label printing program provision apparatus 5 can provide frame information, the information provision apparatus 4 may also be adapted to provide frame information effectively, and further the portable terminal 3 may be adapted to allow the user to request creation of frame information. This case will adopt a system in which the user sends, for example, image data for a corporation's logo mark as raw data for frame information from the portable terminal 3 to the information provision apparatus 4, and in which the information provision apparatus 4 or an entity that manages the apparatus converts and corrects the raw data into frame information suitable for label printing and provides it only to the specific user. To achieve this system, the information provision apparatus 4 needs to have a frame information conversion unit for converting raw data into frame information that is bitmap data and a memory unit for memorizing specific users, in addition to a communication unit for sending/receiving frame information.

Also, for example, the printing data creation program may be embedded in the portable terminal 3 previously. In this case, the label printing program provision apparatus 5 is not needed.

Also, the label printing program provision apparatus 5 and the information provision apparatus 4 may be configured to cooperate with a predetermined charging system. In this case, various charging systems can be applied, such as a system in which a preset amount of money is charged in accordance with provision of the printing data creation program or in accordance with the number of times of provision of frame information.

Although a mobile phone has been assumed as an example of the portable terminal 3 in the above first to third embodiments, the portable terminal 3 is not limited to it as described above. For example, a portable game terminal can be applied, in which case printing data may be created by converting a character that appears in the game into bitmap data or by using a game result, history, record, etc. as text data. Thus, in a game in which a character grows up as the game proceeds, the grown-up and changed character can be printed.

What is claimed is:

1. A label printing system comprising a portable communication terminal and a label printing apparatus for printing a printing image on a tape to create a label,
wherein said portable communication terminal includes
a component kind selection unit for capturing at least one or more selected component kinds constituting a design of said label;
a content information capture unit for capturing inputted content information in accordance with said selected component kinds;
a printing data creation unit for creating printing data based on said content information; and
a terminal-side short-distance wireless communication unit for transmitting said created printing data to said label printing apparatus by short-distance wireless communication, and
wherein said label printing apparatus includes
an apparatus-side short-distance wireless communication unit for receiving said printing data transmitted from said portable communication terminal by short-distance wireless communication; and
a label printing unit for printing a printing image based on said received printing data on a tape to create a label.

2. A label printing system comprising a portable communication terminal, a label printing apparatus for printing a printing image on a tape to create a label, and an information provision apparatus,
wherein said portable communication terminal includes
a component kind selection unit for capturing at least one or more selected component kinds constituting a design of said label;
a content information capture unit for capturing inputted content information in accordance with said selected component kinds;
a content information request unit for, in a case where said component kind selection unit captures at least one or more selected specific component kinds, requesting said information provision apparatus to download content information in accordance with said specific component kinds;
a printing data creation unit for creating printing data based on said content information captured by said content information capture unit and/or said content information acquired as a result of downloading from said information provision apparatus requested by said content information request unit; and
a terminal-side short-distance wireless communication unit for transmitting said created printing data to said label printing apparatus by short-distance wireless communication,
wherein said information provision apparatus includes
a content information storage unit for storing content information in accordance with specific component kinds constituting a design of said label; and
a communication unit for transmitting content information in accordance with specific component kinds requested to be downloaded by said portable communication terminal to said portable communication terminal, and
wherein said label printing apparatus includes
an apparatus-side short-distance wireless communication unit for receiving said printing data transmitted from said portable communication terminal by short-distance wireless communication; and
a label printing unit for printing a printing image based on said received printing data on a tape to create a label.

3. The label printing system according to claim 2,
wherein said information provision apparatus further includes
a label printing program provision unit for providing said portable communication terminal with a label printing program for creating printing data, and
wherein said portable communication terminal further includes
a program acquisition unit for acquiring said label printing program from said label printing program provision unit,
wherein at least said component kind selection unit, said content information capture unit, said content information request unit, and said printing data creation unit function by execution of said acquired label printing program.

4. The label printing system according to claim 3, wherein said label printing program provision unit of said information provision apparatus is adapted to further provide a printing operation control program for giving commands for operations of said label printing apparatus, and
wherein said portable communication terminal includes an operation command unit for giving commands for operations of said label printing apparatus by execution of said printing operation control program.

5. A label printing system comprising a portable communication terminal, a label printing apparatus for printing a printing image on a tape to create a label, and an information provision apparatus,
wherein said information provision apparatus includes
a printing operation control program provision unit for providing a printing operation control program for giving commands for operations of said label printing apparatus,
wherein said portable communication terminal includes
a program acquisition unit for acquiring said printing operation control program from said printing operation control program provision unit;
an operation command unit for giving commands for operations of said label printing apparatus by execution of said printing operation control program; and
a terminal-side short-distance wireless communication unit for transmitting operation commands given by said operation command unit to said label printing apparatus by short-distance wireless communication,
wherein said label printing apparatus includes
an apparatus-side short-distance wireless communication unit for receiving printing data transmitted from said portable communication terminal by short-distance wireless communication; and
a label printing unit for printing a printing image based on said received printing data on a tape to create a label.

6. A label printing method in a system comprising a portable communication terminal and a label printing apparatus for printing a printing image on a tape to create a label,
wherein said portable communication terminal includes
a component kind selection step of capturing at least one or more selected component kinds constituting a design of said label;
a content information capture step of capturing inputted content information in accordance with said selected component kinds;
a printing data creation step of creating printing data based on said content information; and
a terminal-side short-distance wireless communication step of transmitting said created printing data to said label printing apparatus by short-distance wireless communication, and
wherein said label printing apparatus includes
an apparatus-side short-distance wireless communication step of receiving said printing data transmitted from said portable communication terminal by short-distance wireless communication; and
a label printing step of printing a printing image based on said received printing data on a tape to create a label.

7. A label printing method in a system comprising a portable communication terminal, a label printing apparatus for printing a printing image on a tape to create a label, and an information provision apparatus,
wherein said portable communication terminal includes
a component kind selection step of capturing at least one or more selected component kinds constituting a design of said label;
a content information capture step of capturing inputted content information in accordance with said selected component kinds;
a content information request step of, in a case where at least one or more selected specific component kinds is captured in said component kind selection step, requesting said information provision apparatus to download content information in accordance with said specific component kinds;
a printing data creation step of creating printing data based on said content information captured in said content information capture step and/or said content information acquired as a result of downloading from said information provision apparatus in said content information request step; and
a terminal-side short-distance wireless communication step of transmitting said created printing data to said label printing apparatus by short-distance wireless communication,
wherein said information provision apparatus includes
a content information storage unit for storing content information in accordance with specific component kinds constituting a design of said label; and
a communication step of transmitting content information in accordance with specific component kinds requested to be downloaded by said portable communication terminal to said portable communication terminal, and
wherein said label printing apparatus includes
an apparatus-side short-distance wireless communication step of receiving said printing data transmitted from said portable communication terminal by short-distance wireless communication; and
a label printing step of printing a printing image based on said received printing data on a tape to create a label.

8. A label printing method in a system comprising a portable communication terminal, a label printing apparatus for printing a printing image on a tape to create a label, and an information provision apparatus,
wherein said information provision apparatus includes
a printing operation control program provision step of providing a printing operation control program for giving commands for operations of said label printing apparatus,
wherein said portable communication terminal includes
a program acquisition step of acquiring said printing operation control program;
an operation command step of giving commands for operations of said label printing apparatus by execution of said printing operation control program; and
a terminal-side short-distance wireless communication step of transmitting given operation commands to said label printing apparatus by short-distance wireless communication,
wherein said label printing apparatus includes
an apparatus-side short-distance wireless communication step of receiving printing data transmitted from said portable communication terminal by short-distance wireless communication; and
a label printing step of printing a printing image based on said received printing data on a tape to create a label.
